(19) United States
(12) Patent Application Publication
(10) Pub. No.: US 2015/0161358 A1
(43) Pub. Date: Jun. 11, 2015

(54) SYSTEM AND METHOD FOR PERFORMING MEDICAL RESEARCH

(71) Applicant: Brian Meshkin, Irvine, CA (US)

(72) Inventor: Brian Meshkin, Fulton, MD (US)

(21) Appl. No.: 14/099,368

(22) Filed: Dec. 6, 2013

(51) Int. Cl. G06F 19/00

(52) U.S. Cl. CPC G06F 19/36

(57) ABSTRACT

There is a system and a method for performing medical research. The method includes receiving a registration record. The registration record is for documenting a participant's involvement in a clinical trial. The method may also include receiving an evaluation record for documenting biological information associated with the participant in the clinical trial. The method may also include generating a payment record. The payment record may include a payment value associated with the evaluation record. The registration record may include a service authorization. The service authorization may be for a service the participant receives for collecting the biological information.

### BACKGROUND

The advance of medical knowledge is often developed in modern healthcare through various sources. The sources for medical knowledge generally operate as separate spheres in the global medical community. Clinical trials are one such source of medical knowledge. Clinical trials are, in general, situated in an upstream area of medical knowledge that is commonly associated with the research and development of health interventions (e.g., drugs, biologics, diagnostics, devices, therapy protocols, etc.). Clinical trials, such as are often utilized in drug development, include sets of tests to generate data for establishing the safety and efficacy of health interventions. In general, a clinical trial is often conducted after nonclinical information first has been gathered to establish nonclinical safety of a health intervention which is to be tested clinically in the clinical trial. Also, a health authority and/or ethics committee commonly grants their approval before a clinical trial is begun. Clinical trials vary in size and may involve a single research entity in a single country or many such entities in multiple countries. Clinical trials may also be associated with developing theoretical solutions for the practice of medicine.

Another general source of medical knowledge results from patient care in the mainstream practice of medicine by medical professionals (e.g., physicians, nurses, medical technicians, etc.). This source of medical knowledge is commonly associated with patient medical histories compiled in medical records. Similar knowledge in this area is generated by doctors observing patients and publishing articles and related documentation such as individual patient reports and cohort studies. These types of medical knowledge sources describe observations and developments associated with actual patient care in the mainstream practice of medicine. Hence, resources expended through the research and development of health innovations in clinical trials is often not directly associated with improving the health of patients in actual patient care provided by medical professionals in the mainstream practice of medicine.

Clinical trials are enormously expensive and often result in a lack of approval for a proposed health intervention. Furthermore, even in instances in which a health intervention is successfully approved following a clinical trial, there is often a substantial wait or lag period. This period can be a substantial length of time lasting from a few months to several years. It commonly occurs between the time when resources are expended in a clinical trial and the point when a tested health intervention can be broadly applied to benefit patients in actual patient care in the mainstream practice of medicine.

In addition, there is a desire to involve medical professionals in ongoing educational programs. However, medical professionals in the mainstream practice of medicine are seldom involved in research and development undertakings which are still under development through clinical trials. They are not often aware of new developments relating to health interventions still being researched and under development. This can be particularly deleterious for medical specialists that are responsible for providing medical care to a particular genus of patients (e.g., oncologists who care for cancer patients). The genus of patients (e.g., cancer patients) would benefit from their doctor (e.g., an oncologist) having early knowledge of new health interventions specific to the patient genus (e.g., new cancer therapies under development, such as in a clinical trial).

Given the foregoing, systems and methods for performing medical research are desired in which resources expended in clinical trials are more directly applicable to benefit patients under patient care in the mainstream practice of medicine by medical professionals. It is also desired that the systems and methods be implemented to help reduce or eliminate the substantial wait or lag that often occurs between the time when resources are expended within a clinical trial testing a health intervention and the point at which the health intervention can be utilized broadly to benefit patients in the mainstream practice of medicine. It is also desired to engage medical professionals, ordinarily responsible for mainstream patient care, in research and development undertakings which are still in the clinical trial stage. It is desired to engage such healthcare professionals as part of a clinical trial so as to help to make them aware of newly emerging developments relating to health interventions still under development.

### SUMMARY

This summary is provided to introduce a selection of concepts. These concepts are further described below in the detailed description in conjunction with the accompanying drawings. This summary is not intended to identify key features or essential features of the claimed subject matter, nor is this summary intended as an aid in determining the scope of the claimed subject matter.

According to an implementation, there is a method for performing medical research. The method may include receiving a registration record for documentation of a participant in a clinical trial. The method may include storing the received registration record. The method may also include transmitting the received registration record. The method may also include receiving an evaluation record for documentation of the clinical trial including biological information associated with the participant associated with the transmitted registration record. The method may also include storing the received evaluation record. The method may also include generating, utilizing a processor, a payment record including a payment value associated with the received evaluation record. The received registration record may include a service authorization associated with the participant receiving a service associated with collecting the biological information.

According to another implementation, there is a system for performing medical research. The system may include a receiving interface configured to receive registration data for documentation of a participant in a clinical trial. The system may also include a data management module configured to, utilizing a processor, store the received registration data. The system may also include a transmitting interface configured to transmit the received registration data. The receiving interface may be configured to receive evaluation data for documentation of the clinical trial including biological information associated with the participant associated with the transmitted registration data. The data management module may be configured to store the received evaluation data and/or to generate payment data including a payment value associated with the received evaluation data. The received registration data may include a service authorization associated with the participant receiving a service associated with collecting the biological information.

According to another implementation, there is a non-transitory computer-readable medium storing computer readable instructions that when executed by a computer system may perform a method for performing medical research. The method may include receiving a registration record for documentation of a participant in a clinical trial. The method may include storing the received registration record. The method may also include transmitting the received registration record. The method may also include receiving an evaluation record for documentation of the clinical trial including biological information associated with the participant associated with the transmitted registration record. The method may also include storing the received evaluation record. The method may also include generating, utilizing a processor, a payment record including a payment value associated with the received evaluation record. The received registration record may include a service authorization associated with the participant receiving a service associated with collecting the biological information.

The above summary is not intended to describe each embodiment or every implementation. Further features, their nature and various advantages are described in the accompanying drawings and the following detailed description of the examples and embodiments.

### BRIEF DESCRIPTION OF THE DRAWINGS

The accompanying drawings, which are incorporated in and constitute a part of this specification, illustrate one or more embodiments described herein and, together with the description, explain these embodiments. In addition, it should be understood that the drawings are presented for example purposes only. In the drawings:

FIG. 1 is a conceptual diagram illustrating an exemplary overview of an implementation as described herein;

FIG. 2 is a flowchart illustrating an exemplary process for performing medical research as described herein;

FIG. 3 is a block diagram illustrating an exemplary registration record as described herein;

FIG. 4 is a block diagram illustrating an exemplary evaluation record as described herein;

FIG. 5 is a block diagram illustrating an exemplary payment record as described herein;

FIG. 6 is a block diagram illustrating an exemplary research record as described herein;

FIG. 7 is a block diagram illustrating an exemplary DNA diagnostic record as described herein;

FIG. 8 is a block diagram illustrating an exemplary algorithm diagnostic record as described herein;

FIG. 9 is a block diagram illustrating an exemplary system for performing medical research as described herein; and

FIG. 10 is a block diagram illustrating an exemplary platform for performing medical research as described herein.

### DETAILED DESCRIPTION

The following detailed description refers to the accompanying drawings. The same reference numbers in different drawings may identify the same or similar elements.

### Overview

The present invention is useful for performing medical research, and is particularly useful in performing medical research directed to developing diagnostic utilities (e.g., DNA testing panels, diagnostic algorithms, medical devices, therapy protocols, etc.) for health interventions. Systems and methods for performing medical research, according to the principles of the invention, do not have the drawbacks associated with conventional methods of performing medical research in which resources expended in clinical trials are not generally directly beneficial to patients in patient care in the mainstream practice of medicine by healthcare professionals. The systems and methods for performing medical research, according to the principles of the invention, reduce and/or eliminate the substantial wait or lag that often occurs between the time when resources are expended within a clinical trial to test a health intervention and the point at which the health intervention may be applied broadly to benefit patients in the mainstream practice of medicine by healthcare professionals.

In addition, systems and methods for performing medical research, according to the principles of the invention, help to increase the engagement of healthcare professionals in the mainstream practice of medicine in research and development undertakings which are still under development through clinical trials. Healthcare professionals associated with systems and methods for performing medical research, according to the principles of the invention, may be actively engaged so as to gather clinical data and to receive feedback and information regarding new health interventions still under development stage in the clinical trial. Accordingly, the healthcare professionals in the mainstream practice of medicine are made aware of newly emerging developments relating to health interventions relevant to the population of patients under their care. While the present invention is not necessarily limited to such applications, various aspects of the invention are appreciated through a discussion of various examples using this context.

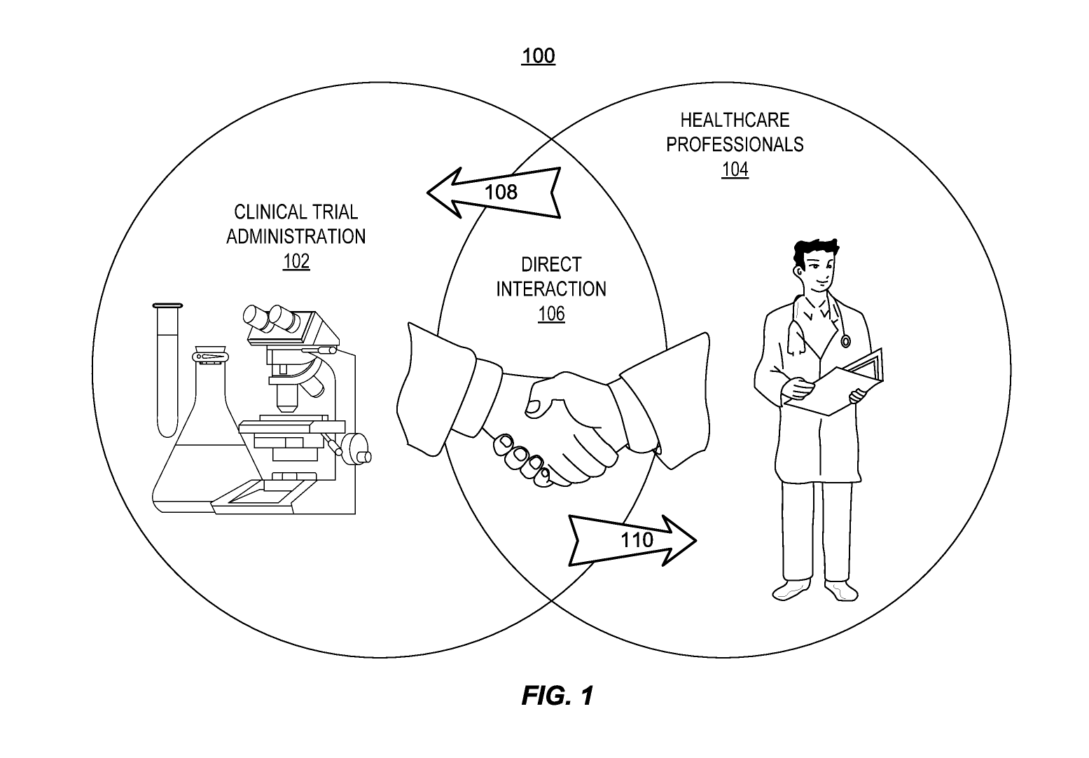

FIG. 1 is a conceptual diagram illustrating an exemplary overview of an implementation according to a principle of the invention. Relationship 100 demonstrates the overlap of two general spheres in the global medical community, research and development and patient care in the practice of mainstream medicine. Research and development including Clinical Trial Administration 102 is represented by a sphere on the left which may include clinical trials as well as other medical research and development efforts. Patient care in the mainstream practice of medicine including Healthcare Professionals 104 is represented by a sphere on the right which may include general medical services provided by physicians, hospitals nurses, medical technicians, as well as services provided by medical specialists, such as oncologists, orthopedists, radiologists, pediatricians, etc.

The two spheres shown in the FIG. 1 overlap at a region, Direct Interaction 106, which is included within both spheres (i.e., 102 and 104). A direct interaction, such as Direct Interaction 106, may include the involvement of Healthcare Professionals 104 in a clinical trial administered by Clinical Trial Administration 102. Direct Interaction 106 may be accomplished through a functional relationship between Clinical Trial Administration 102 and Healthcare Professionals 104. A functional relationship, such as Relationship 100, may be accomplished informally, such as through a voluntary association between Clinical Trial Administration 102 and Healthcare Professionals 104. Relationship 100 may also be accomplished via a formalized relationship between Clinical Trial Administration 102 and Healthcare Professionals 104, such as through a professional services agreement between Clinical Trial Administration 102 and Healthcare Professionals 104. Another variant for Relationship 100 may include a combination that is partially informal and partially formal.

According to an exemplary embodiment, Relationship 100 and/or Direct interaction 106 may be structured to preserve the privacy of a participant in a clinical trial to comply with government privacy regulations, such as, for example, the Health Insurance Portability and Accountability Act of 1996 (HIPAA). According to another exemplary embodiment, Relationship 100 and/or Direct interaction 106 may be structured to comply with applicable regulatory compliance issues, including Federal Compliance issues such as federal Anti-Kickback statutes including but not limited to the Stark law codified under 42 U.S.C. §1395 and related Stark regulations implemented through 42 C.F.R. §411.350, et seq.

Direct Interaction 106 may result in one or more different forms of feedback and/or information streams to Clinical Trial Administration 102, such as Feedback 108 depicted in FIG. 1. Feedback 108 may include, for example, clinical data, such as registration data (e.g., raw data pertaining to a participant in a clinical trial, such as a participant identifier (ID) or demographic information relating to a participant), evaluation data (e.g., a completed case report pertaining to a participant associated with a clinical trial), research data (e.g., a thought project or a publication, such as a cohort study prepared by one or more doctors from among Health Professionals 104), diagnostic data (e.g., biological information associated with a participant, such as genotype information, MRI images, blood test results, genealogical information, diagnosis codes, etc. prepared by one or more doctors from among Health Professionals 104 utilizing a diagnostic utility (e.g., a DNA test or panel, a DNA testing algorithm, a blood test kit, a MRI mechanism, a stethoscope, etc. by one or more doctors from among Health Professionals 104) thought projects, such as a cohort study prepared by one or more doctors from Health Professionals 104) and/or intellectual property which may be generated by Health Professionals 104 via active engagement in Clinical Trial Administration 102 through Direct Interaction 106. Other forms of feedback and/or information streams to Clinical Trial Administration 102 via Feedback 108 are also contemplated.

Direct Interaction 106 may also result in one or more different forms of feedback and/or information streams to Health Professionals 104, such as Feedback 110 depicted in FIG. 1. Feedback 110 may include, for example, a payment value to one or more doctors from among Health Professionals 104. The payment value may be any form of compensation associated with any type of data or service provided to Clinical Trial Administration 102, such as through Feedback 108. For example, a payment value may be monetary amount, such as a fixed fee, that may or may not be mandated by a regulatory scheme. In another example, a payment value may be a fair-market value amount associated with an amount of time a doctor in Health Professionals 104 spends preparing evaluation data transmitted to Clinical Trial Administration 102, such as a period of time spent by the doctor in preparing a completed case report form for documentation of a clinical trial associated with a participant in the clinical trial. Feedback 110 may also include, for example, other type of data transmitted to Clinical Trial Administration 102 including, but not limited to, registration data, evaluation data, research data, diagnostic data, thought projects and/or intellectual property which may be generated by Health Professionals 104 via an active engagement in Clinical Trial Administration 102.

A purpose or goal of Feedback 110 may be to enhance a capability of Health Professionals 104 in providing actual patient care in the mainstream practice of medicine. For example, Feedback 110 may include research data about an ongoing clinical trial administered by Clinical Trial Administration 102. The communication of the research data, such as a monthly report about the progress of a clinical trial may raise the awareness of Health Professionals 104 about recent discoveries and/or developments regarding a health intervention being tested in the clinical trial. A communication of this type of research data is especially beneficial to Health Professionals 104 having a population of patients having medical conditions that are relevant to the health intervention tested in the clinical trial which is reported. Feedback 110 to Healthcare Professionals 104 may also include updates regarding the progress of the clinical trial, as well as metrics and findings generated through analyses of clinical data passed to Clinical Trial Administration 102 via Feedback 108. Other forms of feedback and/or information streams to Healthcare Professionals 104 via Feedback 110 are also contemplated.

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from the examples, as described below. The embodiments on which these examples are based are representative only. The selection of these embodiments to illustrate the principles of the invention does not indicate that materials, components, conditions, techniques, configurations and designs, etc. which are not described in the examples are not suitable for use, or that subject matter not described in the examples is excluded from the scope of the appended claims or their equivalents. The significance of the examples may be better understood by comparing the results obtained therefrom with potential results which may be obtained from tests or trials that may be, or may have been, designed to serve as controlled experiments and to provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present). Also, use of the “a” or “an” is employed to describe elements and components. This is done merely for convenience and to give a general sense of the description. This description should be read to include one or at least one and the singular also includes the plural unless it is obvious that it is meant otherwise.

### Exemplary Medical Research Process

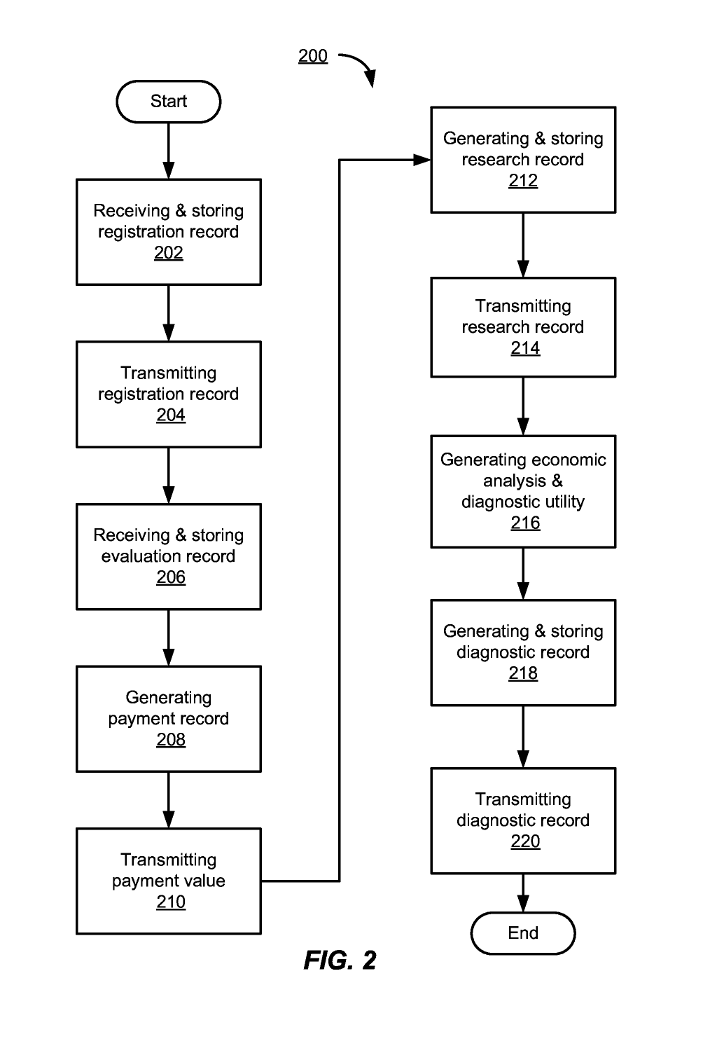

Referring to FIG. 2, depicted is a process 200, which is an exemplary process for performing medical research according to the principles of the invention.

At step 202, the process 200 may include receiving and/or storing a registration record associated with a participant in a clinical trial. A registration record may be in one or a combination of formats. Exemplary formats for a registration record include paper or “hard-copy,” audio communication, a digital data structure and combinations thereof. According to an exemplary embodiment, a registration record may be a digital data structure which may be received via a communications network, such as a local area network, a wide area network and/or the Internet.

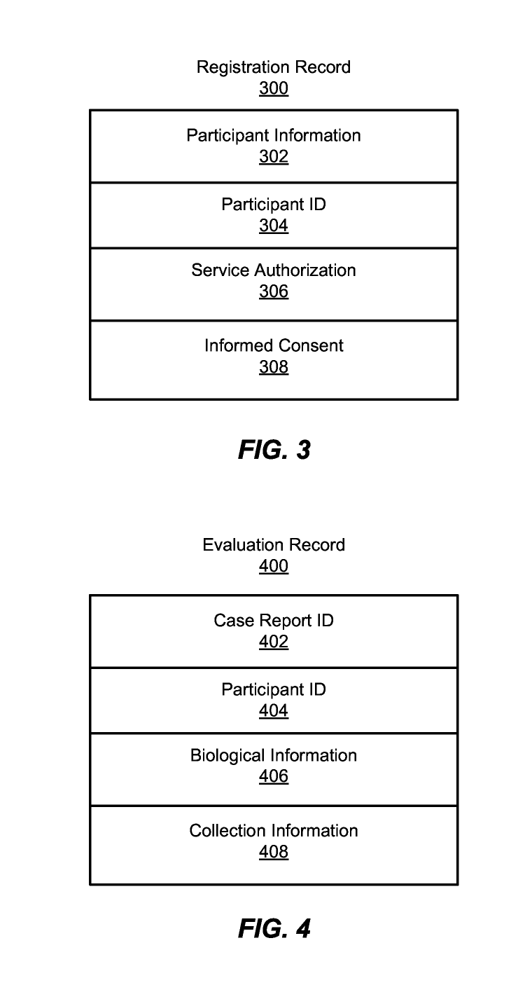

An exemplary digital data structure for a registration record is registration record 300 depicted in FIG. 3. The registration record 300 is depicted to include an exemplary number of exemplary data fields. Registration record 300 includes as exemplary data fields: participant information 302, participant ID 304, service authorization 306 and informed consent 308. Participant information 302 may include, for example, demographic information as well as, for example, personal data which may or may not be encrypted and/or otherwise protected for privacy purposes. Participant ID 304 may be, as examples, randomly generated, sequential and/or based on one or more identifiers associated with a participant. Service authorization 306 may include, for example, documentation and/or confirmation information regarding a service authorization by the participant for receiving a service. The service may be associated with the participant receiving a service associated with collecting biological information, such as a service to collect a DNA sample, a blood sample, image data such as an MRI or X-ray, and the like. Informed consent 308 may include, for example, documentation and/or confirmation information regarding an informed consent given by the participant for participating in a clinical trial. According to an embodiment, both an underlying service authorization by the participant and an informed consent may be collected from two separate contracts executed by the participant. According to another embodiment, both an underlying service authorization by the participant and an informed consent may be collected simultaneously from a single contract executed by the participant.

At step 204, the process 200 may include transmitting a registration record, including for example, some or all of the registration data associated with registration record 300 and related registration data. The registration record may be transmitted to various destinations, including but not limited to, a health care professional, such as one or more of healthcare professionals 104 for preparing evaluation data, such as a case report form for documentation of a clinical trial associated with a participant in the clinical trial.

At step 206, the process 200 may include receiving and storing an evaluation record associated with a participant in a clinical trial. An evaluation record may be in one or a combination of formats. Exemplary formats for a registration record include paper or “hard-copy,” audio communication, a digital data structure and combinations thereof. According to an exemplary embodiment, a registration record may be a digital data structure that may be received via a communications network, such as a local area network, a wide area network and/or the Internet.

An exemplary digital data structure for an evaluation record is evaluation record 400 depicted in FIG. 4. The evaluation record 400 is depicted to include an exemplary number of exemplary data fields. Evaluation record 400 includes as exemplary data fields: case report ID 402, participant ID 404, biological information 406 and collection information 408. Case report ID 402 may be, for example, randomly generated, sequential and/or based on one or more identifiers associated with a participant and/or a clinical trial. Participant ID 404 may be, for example, randomly generated, sequential and/or based on one or more identifiers associated with a participant. Participant ID 404 may be the same or different as participant ID 304 in registration record 400. Biological information 406 may be data associated with, for example, a DNA sample, a blood sample, image data such as an MRI or X-ray, and the like. Collection information 408 may be data associated with the collection of the biological information 406, such as a date and location of the collection, and the like.

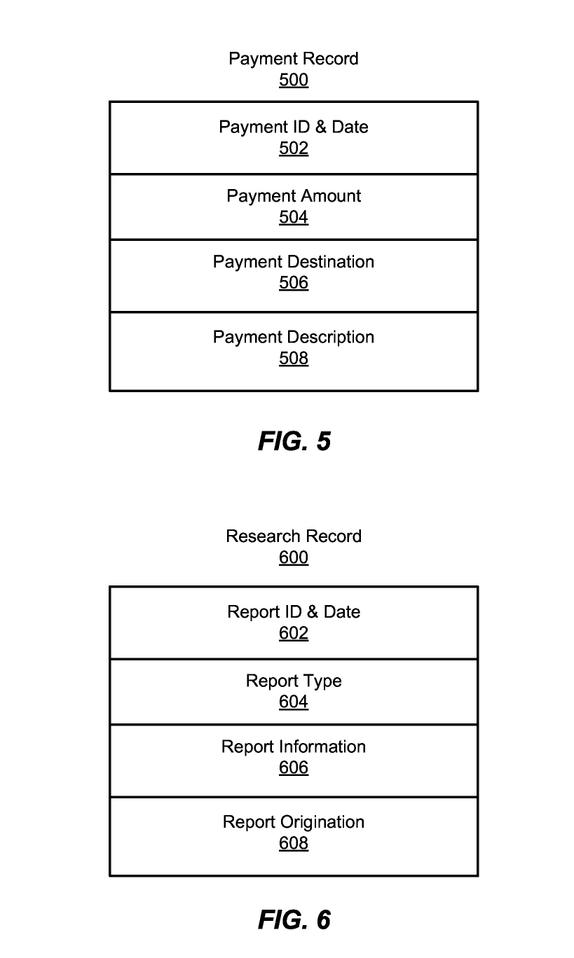

At step 208, the process 200 may include generating, utilizing a processor, a payment record including a payment value associated with the received evaluation record. An exemplary digital data structure for a payment record is payment record 500 depicted in FIG. 5. The payment record 500 is depicted to include an exemplary number of exemplary data fields. Payment record 500 includes as exemplary data fields: payment ID and date 502, payment amount 504, payment destination 506 and payment description 508. Payment amount 504 is a field for data representing a payment value to a healthcare provider for preparing the evaluation data. A payment value may be monetary amount, such as a fixed fee, that may or may not be mandated by a regulatory scheme. In another example, a payment value may be a fair-market value amount associated with an amount of time a healthcare provider spends preparing evaluation data, such as a period of time spent by the healthcare provider in preparing a completed case report form for documentation of a clinical trial associated with a participant in the clinical trial.

At step 210, the process 200 may include transmitting the payment value, such as to a healthcare provider that prepared evaluation data, such as a completed case report form for documentation of a clinical trial associated with a participant in the clinical trial.

At step 212, the process 200 may include generating and storing a research record associated with at least one of the evaluation record and the registration record. A research record may be, for example, a monthly update regarding the progress of a clinical trial. Another example of a research record is a communication regarding new developments relating to health interventions still being researched and under development through a clinical trial. An exemplary digital data structure for a research record is research record 600 depicted in FIG. 6. The research record 600 is depicted to include an exemplary number of exemplary data fields. Research record 600 includes as exemplary data fields: report ID and date 602, report type 604, report information 606 and report origination 608. Research data such as research record 600 may be utilized internally and/or shared externally, such as with healthcare providers that may or may not be associated with a clinical trial associated with the research data.

At step 214, the process 200 may include transmitting a research record, such as research record 600. The research record 600 may be transmitted to various parties, such as a healthcare provider that prepared evaluation data associated with the clinical trial. A research record may also be transmitted internally for developing a diagnostic utility.

At step 216, the process 200 may include generating an economic analysis utilizing a research record, such as research record 600. The research record 600 may be utilized in several ways. One is to perform an economic analysis to identify pharmaco-economic implications and/or advantages to applications of an emerging health intervention in the medical community. The economic analysis may be multi-form and multivariate, such as a cost-minimization analysis, a cost-effectiveness analysis, a cost benefit analysis, a cost-utility analysis and combinations thereof. Exemplary economic analyses and applications thereof are described in “Pharmacogenetic testing: proofs of principle and pharmacoeconomic implications” by Thierry Dervieux, Brian Meshkin and Bruce Neri, Mutation Research/Fundamental and Molecular Mechanisms of Mutagenesis Volume 573, Issues 1-2, 3 Jun. 2005, Pages 180-194, which is incorporated by reference herein in its entirety.

Also at step 216, the process 200 may include generating a diagnostic utility utilizing a research record, such as research record 600. The research record may be utilized to generate a diagnostic utility, such as a DNA panel or an algorithm for interpreting the results of a DNA panel test. Exemplary DNA panels and algorithms are disclosed in “System and Method for Processing Genotype Information Relating to Treatment with Pain Medication,” by Brian Meshkin, U.S. patent application Ser. No. 13/924,540, filed on Jun. 22, 2013, and “System and Method for Processing Genotype Information Relating to Drug Metabolism,” by Brian Meshkin, U.S. patent application Ser. No. 14/065,072, filed on Oct. 28, 2013, which are incorporated by reference herein, in their entirety. Other diagnostic utilities are also contemplated.

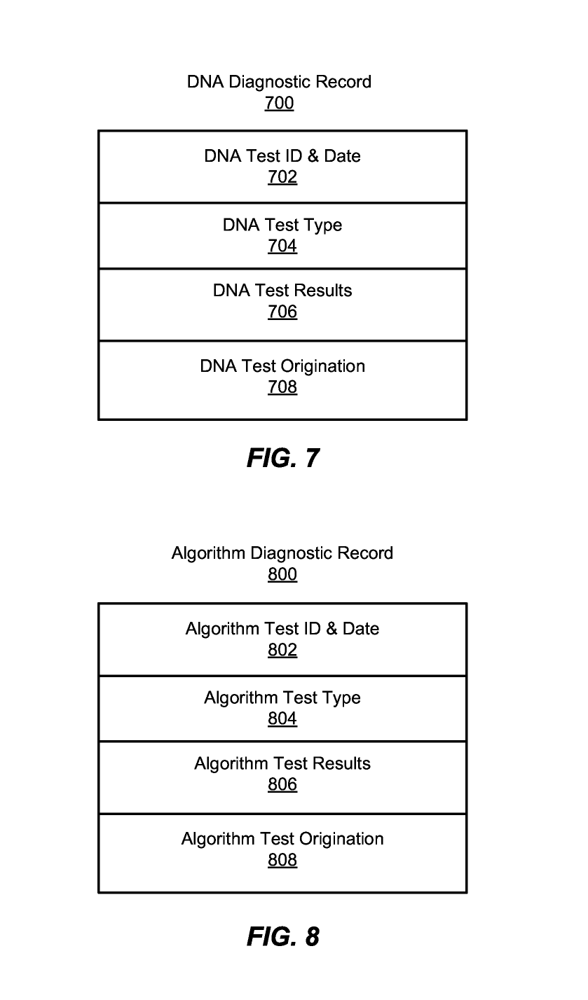

At step 218, the process 200 may include generating and storing a diagnostic record associated with the diagnostic utility. A diagnostic record may be, for example, results from analyzing a biological sample for genotype information. Another example of a diagnostic record may be prognostic information associated with a participant generated by an algorithm analyzing the results a DNA panel test. An exemplary digital data structure for a diagnostic record is DNA diagnostic record 700 depicted in FIG. 7. The DNA diagnostic record 700 is depicted to include an exemplary number of exemplary data fields. DNA diagnostic record 700 includes as exemplary data fields: DNA test ID and date 702, DNA test type 704, DNA test results 706 and DNA test origination 708. Another exemplary digital data structure for a diagnostic record is algorithm diagnostic record 800 depicted in FIG. 8. The algorithm diagnostic record 800 is depicted to include an exemplary number of exemplary data fields. Algorithm diagnostic record 800 includes as exemplary data fields: algorithm test ID and date 802, algorithm test type 804, algorithm test results 806 and algorithm test origination 808. Other diagnostic records are also contemplated.

At step 220, the process 200 may include transmitting a diagnostic record, such as DNA diagnostic record 700 and/or algorithm diagnostic record 800. The diagnostic record(s) may be transmitted to various parties, such as a healthcare provider that prepared evaluation data associated with the clinical trial and/or a participant in the clinical trial.

### Exemplary Medical Research System

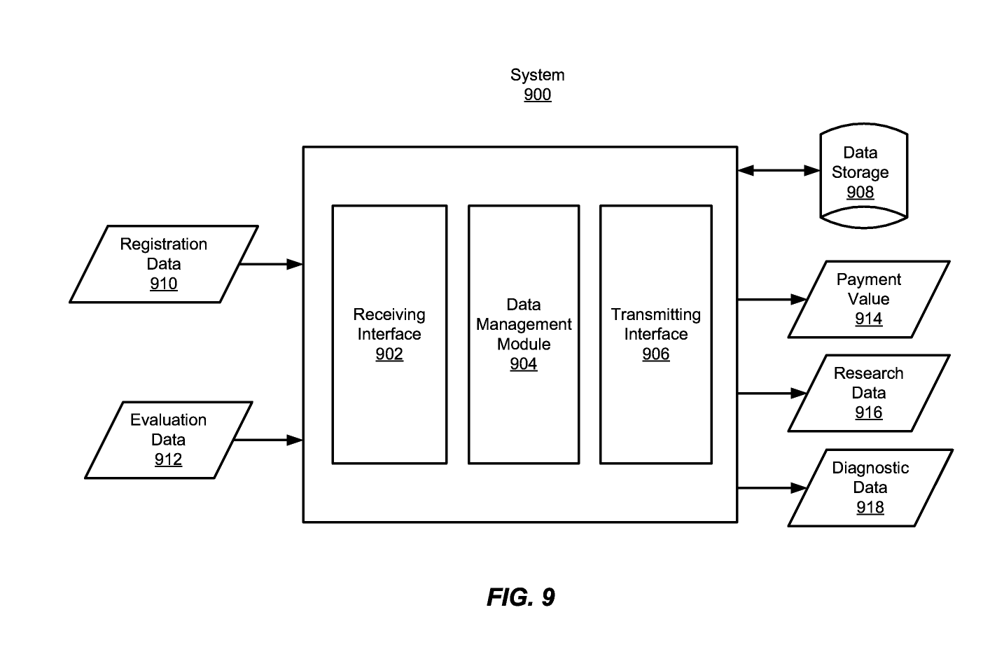

Referring to FIG. 9, depicted is a system 900. The system 900 receives registration data 910, such as the registration record 300, and evaluation data, such as the evaluation record 400, through a receiving interface 902 for processing at a data management module 904 for storing in data storage 908. The data management module 904 may generate various types of data including payment data 914, such as payment record 500, research data 916, such as research record 600, and diagnostic data 918. The payment data 914, the research data 916 and/or the diagnostic data 918 may be stored in data storage 908 or transmitted via a transmitting interface 906 to another system or entity. The transmitting interface 906 may be the same or different as the receiving interface 902.

### Exemplary Platforms

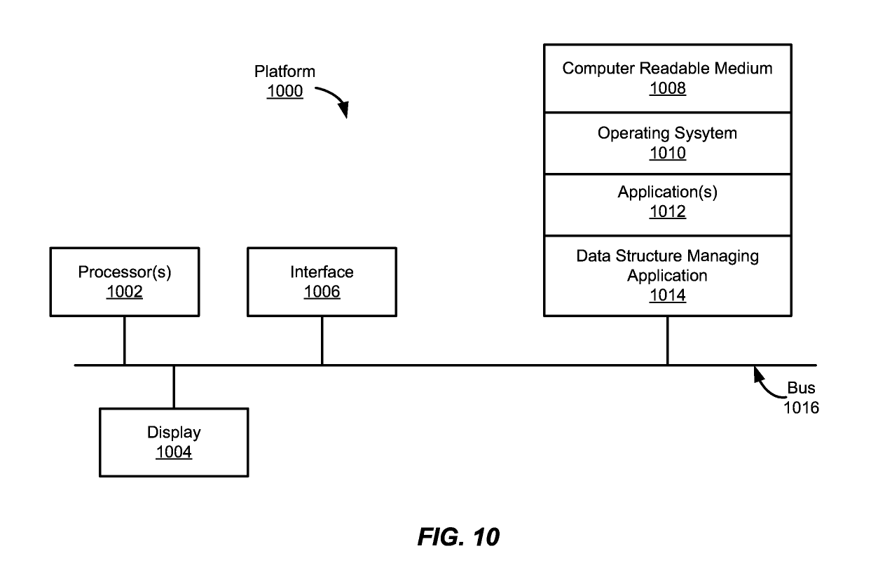

Referring to FIG. 10, there is shown a platform 1000, which may be utilized as a computing device in a medical research system, such as medical research system 900. It is understood that the depiction of the platform 1000 is a generalized illustration and that the platform 1000 may include additional components and that some of the components described may be removed and/or modified without departing from a scope of the platform 1000.

The platform 1000 includes processor(s) 1002, such as a central processing unit; a display 1004, such as a monitor; an interface 1006, such as a simple input interface and/or a network interface to a Local Area Network (LAN), a wireless 802.11x LAN, a 3G or 4G mobile WAN or a WiMax WAN; and a computer-readable medium (CRM) 1008. Each of these components may be operatively coupled to a bus 1016. For example, the bus 1016 may be an EISA, a PCI, a USB, a FireWire, a NuBus, or a PDS.

A CRM, such as CRM 1008 may be any suitable medium which participates in providing instructions to the processor(s) 1002 for execution. For example, the CRM 1008 may be non-volatile media, such as an optical or a magnetic disk; volatile media, such as memory; and transmission media, such as coaxial cables, copper wire, and fiber optics. Transmission media can also take the form of acoustic, light, or radio frequency waves. The CRM 1008 may also store other instructions or instruction sets, including word processors, browsers, email, instant messaging, media players, and telephony code.

The CRM 1008 may also store an operating system 1010, such as MAC OS, MS WINDOWS, UNIX, or LINUX; application(s) 1012, such as network applications, word processors, spreadsheet applications, browsers, email, instant messaging, media players such as games or mobile applications (e.g., “apps”); and a data structure managing application 1014. The operating system 1010 may be multi-user, multiprocessing, multitasking, multithreading, real-time and the like. The operating system 1010 may also perform basic tasks such as recognizing input from the interface 1006, including from input devices, such as a keyboard or a keypad; sending output to the display 1004 and keeping track of files and directories on CRM 1008; controlling peripheral devices, such as disk drives, printers, image capture devices; and for managing traffic on the bus 1016. The applications 1012 may include various components for establishing and maintaining network connections, such as code or instructions for implementing communication protocols including those such as TCP/IP, HTTP, Ethernet, USB, and FireWire.

A data structure managing application, such as data structure managing application 1014 provides various code components for building/updating a computer-readable system architecture, such as for a non-volatile memory, as described above. In certain examples, some or all of the processes performed by the data structure managing application 1012 may be integrated into the operating system 1010. In certain examples, the processes may be at least partially implemented in digital electronic circuitry, in computer hardware, firmware, code, instruction sets, or any combination thereof.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

What is claimed is:

1. A method for performing medical research, comprising:
receiving a registration record for documentation of a participant in a clinical trial;
storing the received registration record;
transmitting the received registration record;
receiving an evaluation record for documentation of the clinical trial including biological information associated with the participant associated with the transmitted registration record;
storing the received evaluation record; and
generating, utilizing a processor, a payment record including a payment value associated with the received evaluation record,
wherein the received registration record includes a service authorization associated with the participant receiving a service associated with collecting the biological information.

2. The method of claim 1, the method comprising
transmitting the generated payment value.

3. The method of claim 1, wherein the received registration record includes an informed consent associated with the participant.

4. The method of claim 3, wherein the service authorization and the informed consent are collected through a single transaction with the participant.

5. The method of claim 1, wherein the biological information includes genotype information associated with the participant.

6. The method of claim 1, wherein the received evaluation record includes a case report, prepared by a healthcare provider, for documentation of the clinical trial.

7. The method of claim 1, wherein the generated payment value is associated with an amount of time expended by a healthcare provider in preparing a case report for documentation of the clinical trial.

8. The method of claim 1, the method comprising at least one of
generating a research record associated with at least one of the received evaluation record and the received registration record;
generating an economic analysis associated with the generated research record;
storing at least one of the generated research record and the generated economic analysis; and
transmitting at least one of the generated research record and the generated economic analysis.

9. The method of claim 8, the method comprising at least one of
generating a diagnostic utility utilizing at least one of the received evaluation record and the generated research record;
generating a diagnostic record associated with the participant, optionally utilizing the generated diagnostic utility;
storing the generated diagnostic record; and
transmitting the generated diagnostic record.

10. The method of claim 9, wherein the generated diagnostic utility is at least one of a DNA test and an algorithm test.

11. A system for performing medical research, the system comprising:
a receiving interface configured to receive registration data for documentation of a participant in a clinical trial;
a data management module configured to, utilizing a processor, store the received registration data; and
a transmitting interface configured to transmit the received registration data,
wherein the receiving interface is configured to receive evaluation data for documentation of the clinical trial including biological information associated with the participant associated with the transmitted registration data,
wherein the data management module is configured
to store the received evaluation data, and
to generate payment data including a payment value associated with the received evaluation data, and
wherein the received registration data includes a service authorization associated with the participant receiving a service associated with collecting the biological information.

12. The system of claim 11, wherein the transmitting interface is configured to transmit the generated payment value.

13. The system of claim 11, wherein the received registration data includes an informed consent associated with the participant.

14. The system of claim 13, wherein the service authorization and the informed consent are collected through a single transaction with the participant.

15. The system of claim 11, wherein the biological information includes genotype information associated with the participant.

16. The system of claim 11, wherein the received evaluation data includes a case report, prepared by a healthcare provider, for documentation of the clinical trial.

17. The system of claim 11, wherein the payment value is associated with an amount of time expended by a healthcare provider in preparing a case report for documentation of the clinical trial.

18. The system of claim 11, wherein the data management module is configured to perform at least one of
generate research data associated with at least one of the received evaluation data and the received registration data,
generate an economic analysis associated with the generated research record,
store at at least one of the generated research data and the generated economic analysis, and
transmit at least one of the generated research data and the generated economic analysis.

19. The system of claim 18, wherein the data management module is configured to perform at least one of
generate a diagnostic utility utilizing at least one of the received evaluation data and the generated research data,
generate diagnostic data associated with the participant, optionally utilizing the generated diagnostic utility,
store the generated diagnostic data, and
transmit the generated diagnostic data.

20. A non-transitory computer readable medium storing computer readable instructions that when executed by a computer system perform a method for performing medical research, the method comprising:
receiving a registration record for documentation of a participant in a clinical trial;
storing the received registration record;
transmitting the received registration record;
receiving an evaluation record for documentation of the clinical trial including biological information associated with the participant associated with the transmitted registration record;
storing the received evaluation record; and
generating, utilizing a processor, a payment record including a payment value associated with the received evaluation record,
wherein the received registration record includes a service authorization associated with the participant receiving a service associated with collecting the biological information.
